(19) United States
(12) Patent Application Publication
(10) Pub. No.: US 2024/0096304 A1
(43) Pub. Date: Mar. 21, 2024

(54) MAGNETIC PICKUP SYSTEMS FOR STRINGED INSTRUMENTS

(71) Applicant: Duneland Labs, LLC, Chicago, IL (US)

(72) Inventor: F. Robert Palmieri, III, Gary, IN (US)

(21) Appl. No.: 18/471,600

(22) Filed: Sep. 21, 2023

Related U.S. Application Data
(60) Provisional application No. 63/376,476, filed on Sep. 21, 2022.

(51) Int. Cl. G10H 3/18

(52) U.S. Cl. CPC G10H 3/181

(57) ABSTRACT

Magnetic pickup systems suitable for use with stringed instruments and methods for their use. Such a pickup system includes a wire coil that has an axis and is wound onto a core of a coil bobbin, and magnetic strips outside the wire coil. The magnetic strips each have a polarization axis orthogonal to the axis of the wire coil. A longitudinal center of the coil bobbin is populated with core elements having high gauss permanent magnets attached thereto. The high gauss permanent magnets each have an axis of polarization disposed parallel to the axis of the wire coil and therefore in an orthogonal orientation to the polarization axes of the outboard magnetic strips. A method of using such a pickup system includes adjusting one or more of the core elements relative to the outboard magnetic strips to allow for selectively and individually increasing a range of flux field geometries of one or more strings of the stringed instrument.

### CROSS-REFERENCE TO RELATED APPLICATIONS

This application claims the benefit of U.S. Provisional Application No. 63/376,476 filed Sep. 21, 2022, the contents of which are incorporated herein by reference.

### BACKGROUND OF THE INVENTION

The present invention generally relates to magnetic pickup systems for stringed instruments. The invention particularly relates to magnetic pickup systems that employ a combination of magnetic materials, orientations, and alignments which enable improved response to string behavior.

### BRIEF DESCRIPTION OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, magnetic pickup systems suitable for use with stringed instruments and methods for their use.

According to a nonlimiting aspect of the invention, a pickup system includes a wire coil that has an axis and is wound onto a core of a coil bobbin, and magnetic strips outside the wire coil. The magnetic strips each have a polarization axis orthogonal to the axis of the wire coil. A longitudinal center of the coil bobbin is populated with core elements having high gauss permanent magnets attached thereto. The high gauss permanent magnets each have an axis of polarization disposed parallel to the axis of the wire coil and therefore in an orthogonal orientation to the polarization axes of the outboard magnetic strips.

According to another nonlimiting aspect of the invention, a method is provided for using a pickup system as described above. The method includes adjusting one or more of the core elements relative to the outboard magnetic strips to allow for selectively and individually increasing a range of flux field geometries of one or more strings of the stringed instrument.

Technical effects of magnetic pickup systems and methods as described above preferably include the ability to improve the response to string behavior of a stringed instrument.

Other aspects and advantages of this invention will be appreciated from the following detailed description.

### BRIEF DESCRIPTION OF THE DRAWINGS

FIGS. 1A, 1B, 2, and 3 schematically represent nonlimiting embodiments of magnetic pickup systems intended for use with stringed instruments, as a nonlimiting example, an electric guitar.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

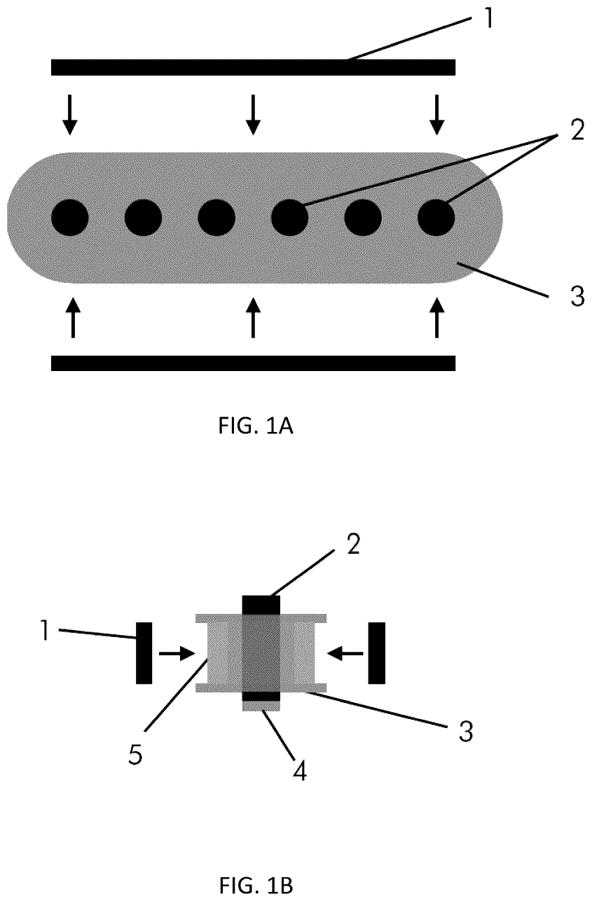

FIGS. 1A through 3 represent nonlimiting embodiments of systems and components intended for use with instruments with strings that contain some measure of magnetically permeable material, including but not limited to strings of an electric guitar.

FIGS. 1A and 1B schematically represent components of a magnetic pickup system as comprising a coil bobbin 3 having a core on which a wire coil 5 is wound, and outboard magnetic strips 1 (as a nonlimiting example, strips of ceramic or ceramic-impregnated material) located outside of the wire coil 5 on opposite longitudinal sides of the coil bobbin 3 between upper and lower flanges of the coil bobbin 3 so that the polarization axes of the magnetic strips 1 are oriented orthogonal to the axes of the wire coil 5. The approximate longitudinal center of the core of the coil bobbin 3 is populated with core elements 2 to which high gauss permanent magnets 4 are attached.

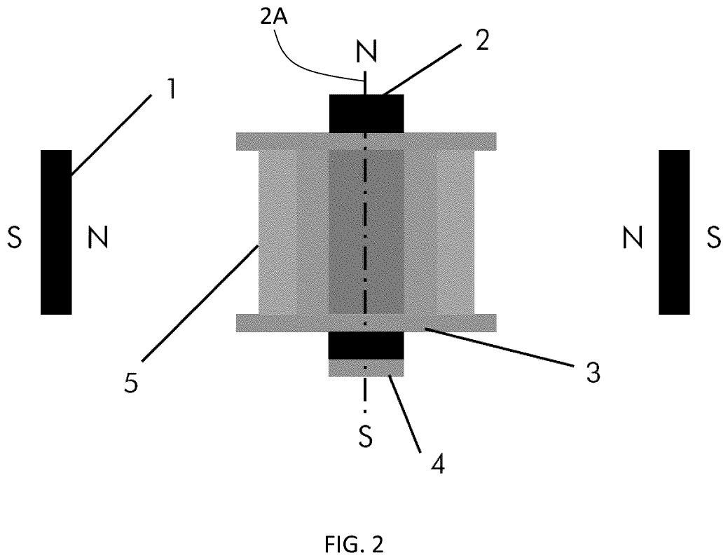

As represented in FIG. 2, the core elements 2 each have an axis of polarization 2A disposed parallel to the axis of the wire 5 and orthogonal to the polarization axes of the outboard magnetic strips 1. Adjustment of these core elements 2 relative to the strips 1 enables a range of flux field geometries. As a nonlimiting example, with the magnetic pickup system located in functional proximity to strings of a stringed instrument, by adjusting one or more of the core elements 2 relative to the outboard magnetic strips 1, for example, by repositioning a core element 2 along its axis of polarization 2A (i.e., moving the core element 2 within and relative to the coil bobbin 3), a range of flux field geometries of one or more of the strings can be selectively and individually increased (or otherwise modified). Alternatively or additionally, adjusting one or more of the core elements 2 relative to the outboard magnetic strips 1 may be achieved by adjusting the strength (gauss) of individual permanent magnets 4 of one or more of the core elements 2, for example, by replacing an individual permanent magnet 4 on a core element 2.

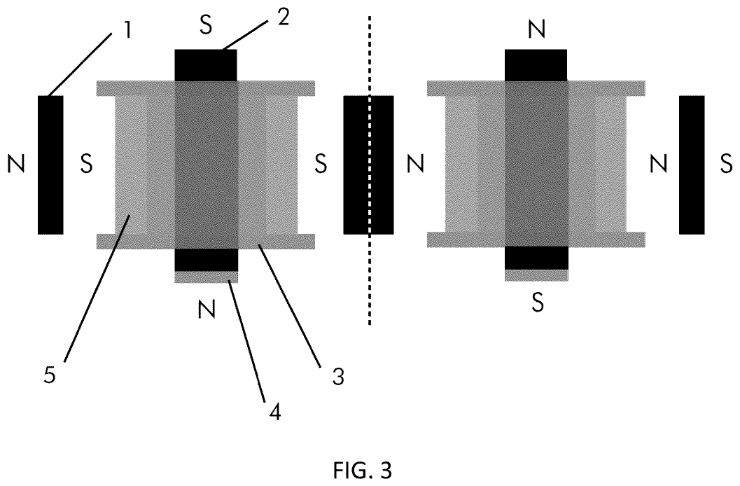

As represented in FIG. 3, additional wire coils located in the same enclosure as the coil bobbin 3 of FIGS. 1A, 1B, and 2 can receive flux solely from the outboard magnetic strips 1 of the coil bobbin 3 if desired, using core elements without directly attached high gauss permanent magnets. This allows for a complex overall field structure and allows for the establishing of a desired ratio of response between the disparately-magnetized wire coils.

As previously noted above, though the foregoing detailed description describes certain aspects of one or more particular embodiments of the invention, alternatives could be adopted by one skilled in the art. For example, the magnetic pickup systems and their components could differ in appearance and construction from the embodiments described herein and shown in the drawings, functions of certain components of the magnetic pickup systems could be performed by components of different construction but capable of a similar (though not necessarily equivalent) function, and various materials could be used in the fabrication of the magnetic pickup systems and/or their components. As such, and again as was previously noted, it should be understood that the invention is not necessarily limited to any particular embodiment described herein or illustrated in the drawings.

1. A pickup system for an instrument having strings, the system comprising:
a wire coil wound onto a core of a coil bobbin, the wire coil having an axis; and
magnetic strips outside the wire coil, the magnetic elements each having a polarization axis orthogonal to the axis of the wire coil;
wherein a longitudinal center of the coil bobbin is populated with core elements having high gauss permanent magnets attached thereto, the high gauss permanent magnets each having an axis of polarization disposed parallel to the axis of the wire coil and therefore in an orthogonal orientation to the polarization axes of the magnetic strips.

2. The pickup system of claim 1, further comprising:
an enclosure containing the wire coil and the coil bobbin; and
at least one additional wire coil within the enclosure that receives flux solely from the outboard magnetic strips.

3. The pickup system of claim 1, wherein the high gauss permanent magnets are directly attached to the core elements.

4. The pickup system of claim 1, wherein the high gauss permanent magnets are not directly attached to the core elements to allow for a complex overall field structure and for the establishing of a predetermined ratio of response between disparately-magnetized wire coils.

5. A method of using the pickup system of claim 1 with an instrument having strings, the method comprising adjusting one or more of the core elements relative to the outboard magnetic strips to allow for selectively and individually increasing a range of flux field geometries of one or more of the strings of the instrument.

6. The method of claim 5, wherein the adjusting of the one or more of the core elements comprises repositioning a core element along the axis of polarization thereof.

7. The method of claim 5, wherein the adjusting of the one or more of the core elements comprises adjusting the strength of one or more of the high gauss permanent magnets of the one or more of the core elements.
